(19) United States
(12) Patent Application Publication
(10) Pub. No.: US 2014/0228066 A1
(43) Pub. Date: Aug. 14, 2014

(54) Method and Device for Processing Context

(71) Applicant: Huawei Technologies Co., Ltd., Shenzhen (CN)

(72) Inventors: Dong Zhao, Shenzhen (CN); Lan Zou, Shenzhen (CN)

(73) Assignee: HUAWEI TECHNOLOGIES CO., LTD., Shenzhen (CN)

(21) Appl. No.: 14/252,541

(22) Filed: Apr. 14, 2014

Related U.S. Application Data
(63) Continuation of application No. PCT/CN2012/083231, filed on Oct. 19, 2012.

(30) Foreign Application Priority Data
Oct. 21, 2011 (CN) 201110323711.9

(51) Int. Cl. H04W 76/02; H04W 72/04; H04W 24/04

(52) U.S. Cl. CPC H04W 76/027; H04W 24/04; H04W 72/048
USPC 455/514

(57) ABSTRACT

The present invention provides a method and device for processing context, which relate to communication filed. The method includes storing UE context of a UE. If the UE encounters RLF, acquiring RLF context of the UE and matching the UE context with the RLF context. By adopting the method and the device of the present invention, the RLF context can be matched with the UE context

This application is a continuation of International Application No. PCT/CN2012/083231, filed on Oct. 19, 2012, which claims priority to Chinese Patent Application No. 201110323711.9, filed on Oct. 21, 2011, both of which are hereby incorporated by reference in their entireties.

### TECHNICAL FIELD

The present invention relates to communication technology field, and more particular to a method and device for processing context.

### BACKGROUND

In the related art, if a userequipment (UE) loses wireless connection with a base station, namely the UE encounters radio link failure (RLF), the UE will record an RLF event, and resend a connection establishment request to the base station. If the UE can be reconnected with the former base station, the UE reports RLF data to the base station, and the moment when the RLF occurs and the radio environment around the UE can be known by using the data. The technology requires that the UE can be reconnected to the former base station and the former base station can still identify the UE.

But in reality, because the reason why the UE encounters the RLF is not eliminated within a period of time, the UE cannot be reconnected to the base station, or the UE can only be connected to another base station. Even if the former base station acquires the RLF context of the UE, the RLF context cannot be identified. As a result, the RLF context cannot be fully utilized.

### SUMMARY OF THE INVENTION

The embodiments of the present invention provide a method and device for processing context, which enable a base station to match RLF context with UE context.

In order to fulfill the aforementioned objective, the embodiments of the present invention adopt the following technical solutions a method for processing context includes storing UE context of a user equipment; acquiring RLF context of the UE if the UE encounters radio link failure; and matching the UE context with the RLF context.

Alternatively, the present invention provides another method for processing context including receiving data of a task of a user equipment and radio link failure data of the UE. The data of the task of the UE carries UE context of the UE, and the RLF data carries RLF context of the UE. The method further includes associating the data of the task of the UE with the RLF data, according to the UE context and the RLF context.

An device for processing context includes a memory configured to store UE context of a user equipment, and a transceiver configured to acquire RLF context of the UE if the UE encounters radio link failure. A processor is configured to match the UE context stored by the memory with the RLF context acquired by the transceiver.

Alternatively, the present invention provides another device, including a transceiver configured to receive data of a task of a user equipment and radio link failure data of the UE. The data of the task of the UE carries UE context of the UE, and the RLF data carries RLF context of the UE. A processor is configured to associate the data of the task of the UE with the RLF data, according to the UE context and the RLF context.

In aforementioned the technical solutions, UE context can be continuously stored, that is to say, after a UE encounters RLF, the UE context of the UE is still stored in a base station, so that after received RLF context of the UE, the base station can match the RLF context with the UE context, which is favorable for fully utilizing the RLF context of the UE by the base station.

### BRIEF DESCRIPTION OF THE DRAWINGS

In order to illustrate the technical solution in the embodiments of the present invention or the prior art more clearly, brief description will be made below to the drawings required in the embodiments of the present invention or the prior art, and apparently, the drawings described below are some embodiments of the present invention only, and other drawings could be obtained based on these drawings by those ordinary skilled in this art without creative efforts.

FIG. 1 is a flowchart of a method for processing context in the embodiments of the present invention;

FIG. 2 is a flowchart of a method for processing context in the embodiments of the present invention;

FIG. 3 is a flowchart of a method for processing context in the embodiments of the present invention;

FIG. 4 is a flowchart of a method for processing context in the embodiments of the present invention;

FIG. 5 is a structure diagram of device for processing context in the embodiments of the present invention;

FIG. 6 is a structure diagram of device for processing context in the embodiments of the present invention;

FIG. 7 is a structure diagram of device for processing context in the embodiments of the present invention; and

FIG. 8 is a structure diagram of device for processing context in the embodiments of the present invention.

### DETAILED DESCRIPTION OF ILLUSTRATIVE EMBODIMENTS

The technical solutions in the embodiments of the present invention are hereinafter described in detail and completely, with reference to accompanying drawings in the embodiments of the present invention. Apparently, the described embodiments are only a part, but not all, of the embodiments of the present invention. All of the other embodiments that are obtained by those skilled in the art based on the embodiments in the invention without any inventive efforts fall into the scope protected by the present invention.

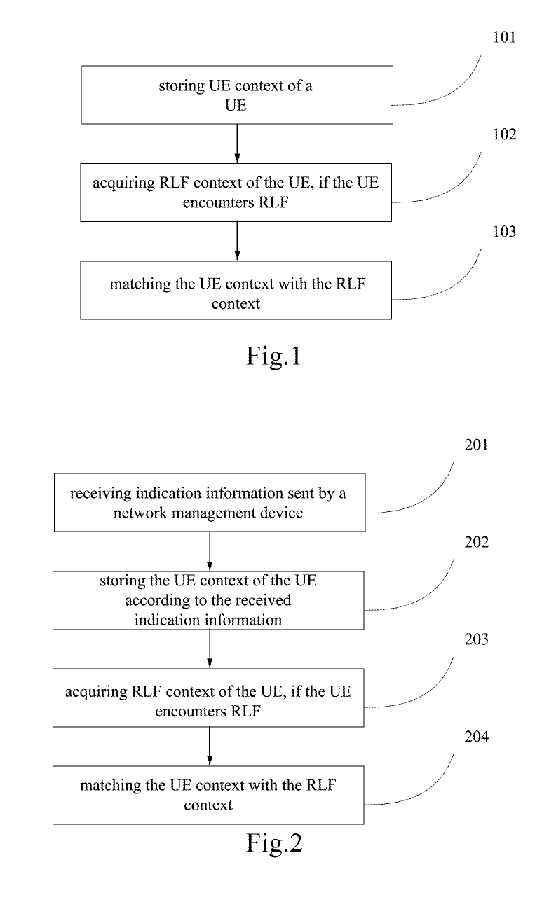

An embodiment of the present invention provides a method for processing context. The subject of the method comprises but not limited to a core network device and an access network device, for example, the core network device comprises a mobility management entity (MME), a serving GPRS support node (SGSN), or a mobile switching center (MSC) and the like, and the access network device comprises a base station, a radio network controller (RNC) or a base station controller (BSC) and the like. This embodiment will be described by taking an access network device as an example. As shown in FIG. 1, the embodiment comprises the following steps.

101: storing UE context of a UE.

Alternatively, an access network device stores the UE contest of the UE, when the UE connected successfully with the access network of the access network device, or when the location of the UE is updated successfully. Alternatively, the access network device acquires that the UE context of the UE is required to be stored, and then stores the UE context.

Alternatively, the UE context stored by the access network device meets a type requirement or a size requirement, or duration that the access network device stores the UE context meets a time length requirement, or number of times that the access network device stores the UE context meets a number-of-times requirement. The aforementioned requirements can be indicated by indication information, which received by the access network device from another device such as a network management device.

Alternatively, after the UE encounters RLF, the access network device matches the stored UE context with RLF context of the UE to identify the UE or a session related with the UE.

Alternatively, the UE context includes one or more of the following identifiers, which including an S1 application protocol (S1AP) identifier, a calling number, a session identifier, a cell radio network temporary identifier (C-RNTI) or a short message authentication code (Short-MAC) identifier of the UE.

102: acquiring RLF context of the UE, if the UE encounters RLF.

For example, when the UE encounters RLF, the UE reports RLF context to the access network device. Also, before the UE encounters the RLF, the UE learns that the access network device requires RLF contextreported, and when the UE encounters the RLF, the UE reports the RLF context to the access network device. Also, after the UE encounters RLF, the UE learns that the access network device requires the RLF context reported, and then reports the RLF context to the access network device.

Alternatively, the RLF context includes one or more of the following identifiers, which including an S1AP identifier, a calling number, a session identifier, a C-RNTI or a Short-MAC identifier of the UE.

103: matching the UE context with the RLF context.

For example, determining the relation between the UE context and the RLF context, such as the same, or partially same, or including or included relations and so on.

In this embodiment, the UE context of the UE can be stored continuously, so that the problem that RLF context of the UE cannot be fully utilized due to improper release of the UE context is solved, the RLF context reported after the UE encounters the RLF can be matched with the UE context of the UE, which is favorable for network optimization.

Another embodiment of the present invention provides a method for processing context. The subject of the method can be a core network device such as a MME, a SGSN or a MSC and the like, and also can be an access network device such as a base station, a RNC or a BSC and the like. This embodiment will be described by taking an access network device as an example. As shown in FIG. 2, this embodiment includes the following steps.

201: receiving indication information sent by a network management device, wherein the indication information is used for indicating to store the UE context.

The indication information has multiple implementations, which is not limited by the present invention. For example, the indication information can be used for indicating a specific requirement, and the specific requirement is anyone of the following items: a type requirement of UE context required to be stored, a size requirement of UE context required to be stored, a time length requirement for storing UE context, and a number-of-times requirement for storing UE context. Namely, the indication information can be regarded to indicate storing UE context, and also indicates the specific requirement for storing UE context at the same time. Also, the indication information can be divided into two parts, wherein the first part of the indication information is used for indicating storing the UE context, and the second part of the indication information is used for indicating the aforementioned specific requirements. Also, the indication information can only indicate storing the UE context, and does not need to indicate the specific requirements.

The network management device sends the indication information to enable the access network device to store the UE context continuously, so that improper release of the UE context is avoided.

202: storing the UE context of the UE according to the received indication information.

If the specific requirement for storing the UE context is learnt, the UE context stored in this step meets the specific requirement. For example, the UE context meets a type requirement of the UE context required to be stored, which is indicated by the aforementioned indication information, or a size requirement of the UE context required to be stored, which is indicated by the aforementioned indication information. Also, time length when the access network device stores the UE context meets a time length requirement for storing the UE context, which is indicated by the aforementioned indication information, for example, the time length does not exceed the time length upper limit indicated by the indication information. Preferably, the time length upper limit is greater than duration of the reason that the UE encounters the RLF. Also, number of times that the access network device stores the UE context meets a number-of-times requirement for storing the UE context, which is indicated by the aforementioned indication information, for example, the number of times for storing the UE context does not exceed upper limit of storing number of times indicated by the indication information.

Alternatively, when the access network device is successfully connected with the UE, or when the position of the UE is successfully updated, step 202 is performed.

Alternatively, the UE context includes one or more of the following identifiers, which including an S1AP identifier, a calling number, a session identifier, a C-RNTI or a Short-MAC identifier of the UE.

203: acquiring RLF context of the UE, if the UE encounters RLF.

For example, after a reason that the UE encounters RLF is eliminated, the UE can be reconnected to the access network device, and sends the RLF context of the UE to the access network device.

For another example, after the UE encounters RLF, the UE is connected to another access network device. and sends RLF context to the another access network device, and the another access network device receives and forwards the RLF context, for example, using an access network interface (X2 or Iur interface) for forwarding, so that the access network device in this embodiment receives the RLF context of the UE through the network element device. If the X2 or Iur interface does not exist between access network devices, the RLF context is forwarded (forwarded to the original access network device through an S1 or Iu interface) through a core network device.

Alternatively, the RLF context includes one or more of the following identifiers, which including an S1AP identifier, a calling number, a session identifier, a C-RNTI or a Short-MAC identifier of the UE.

204: matching the UE context with the RLF context.

Alternatively, matching in this step includes anyone of the following items: determining whether the UE context and the RLF context are the same; or, determining whether the UE context and the RLF context are partially same; or, determining whether the UE context is included in the RLF context; or, determining whether the RLF context is included in the UE context. If the results of the aforementioned determining actions are yes, the UE context is matched with the RLF context.

According to the method for processing the context, provided in the embodiment of the present invention, before an access network device stores UE context, one or more pieces of indication information for storing the UE context and/or limiting the type, size, storing time length or storing number-of-times of the stored UE context are sent to the access network device. After a UE encounters RLF, the access network device continuously preserves the UE context according to the indication information, and after RLF context of the UE is received, the access network device matches the RLF context with the preserved UE context, so that the problem that the RLF context of the UE cannot be fully utilized due to improper release of the UE context in the prior art is solved, the RLF context reported after the UE encounters the RLF can be matched with the UE context of the UE, which is favorable for network optimization.

Moreover, in the method for processing the context provided in the embodiment of the present invention, when the UE is connected to another access network device, the former access network device can acquire the RLF context from the new access network device through an access network interface, so that the problem that the RLF context cannot be transmitted to the former access network device in the absence of the X2 interface in the access network device when the UE is connected to the another access network device is solved.

In another implementation of this embodiment, when the access network device acquires the RLF context in the aforementioned step 203, RLF data of the UE are also acquired. Alternatively, the RLF context and the RLF data are simultaneously sent to the access network device by the UE, or simultaneously forwarded to the access network device by the UE through another access network device. The “simultaneously” here can refer to that the sending time of the RLF context and the sending time of the RLF data can be the same or substantially same, the RLF context and the RLF data are carried by the same message, or the message for carrying the RLF context and the message for bearing the RLF data are the same.

Another embodiment of the present invention provides a method for processing context, and the subject of the method can be a core network device such as a MME, a SGSN or a MSC and the like, and also can be an access network device such as a base station, a RNC or a BSC and the like. This embodiment will be described by taking an access network device as an example. In this embodiment, after UE context is matched with acquired RLF context, RLF data are associated with data of a task of the UE, the associated data are reported to a network management device, and the network management device performs conjoint analysis on the associated data to find the reason that the UE encounters the RLF and to provide accurate basis for later network optimization. The task of the UE in this embodiment includes but not limited to minimum drive test (MDT), radio resource management (RRM) measurement, quality of service (QoS) measurement or quality of experience (QoE) measurement. For example, this embodiment can include steps 201 to 204 in the aforementioned embodiment, also includes a step of associating the RLF data and data of a task of the UE, and can also include a step of reporting the associated data to the network management device.

In another implementation of this embodiment, after the access network device acquires RLF data, the access network device can send data of a task of the UE and the RLF data to a network management device, and the network management device associates the data of the task of the UE and the RLF data and analyzes the associated data.

In another implementation of this embodiment, before step 203, a correspondence between an identifier of a task of the UE and the UE context can also be stored for identifying the UE or a session related with the UE later. Specifically, when the network management device activates a task of the UE, the network management device indicates an access network device to store identifier of the task of the UE and the UE context in a mapping relation table. For example, the indication form may sent a cell radio network temporary identifier is mapping trace (IsMappingTrace-C-RNTI) message to the access network device; the value of the indication message is 0 represents that it is needed that the access network device stores the identifier of the task of the UE and the UE context in the mapping relation table; and the value of the message is −1 represents that it is not needed that the access network device stores the identifier of the task of the UE and the UE context in the mapping relation table. It shall be understood that, the effect of storing the correspondence between identifier of a task of the UE and the UE context can be the same as the effect that the network management device informs the access network device of storing the UE context in the aforementioned embodiment, namely, for identifying the UE or a session related with the UE.

Alternatively, storing the task identifier of the UE and the UE context in the mapping relation table includes any one of the following conditions. A mapping relation table may be established for the UE. The mapping relation table includes the correspondence between the identifier of the task of the UE and the UE context. The mapping relation table for the UE may be updated. The updated mapping relation table comprises the correspondence between the identifier of the task of the UE and the UE context.

This embodiment can include the steps of acquiring RLF context after the correspondence between identifier of a task of a UE and the UE context is stored and matching the UE context with the acquired RLF context, which are the same as steps 203 and 204 in the aforementioned embodiment and are not repeated here. After the UE context is matched with the acquired RLF context, the access network device finds out the relation between data of the task of the UE and the RLF data according to the correspondence table, and associates the data of the task of the UE and the RLF data. Or, the access network device reports the task data of the UE and the RLF data to the network management device and the network management device associates the data of the task of the UE and the RLF data. The association method may be as follows: the data of the task of the UE carries the identifier of the task of the UE and the corresponding terminal identifier thereof, and the RLF data carries the terminal identifier. The network management device associates the data of the task of the UE and the RLF data.

An identifier of a task of the UE can be TR, or TRSR, or combination of the TR and the TRSR. The terminal identifier can be international mobile subscriber identification number (IMSI), international mobile equipment identity (IMEI) or user number.

It shall be noted that, the aforementioned association can also be performed by using the S1AP identifier; when the RLF context does not carry the S1AP identifier, the access network device searches the S1AP identifier according to the C-RNTI or Short-MAC identifier included in RLF context, meanwhile, the core network device can find the corresponding S1AP identifier from the task identifier of the UE and return the S1AP identifier to the access network device, and the access network device associates the RLF data and the data of the task of the UE by using the S1AP identifier; or the access network device reports the S1AP identifier and the RLF data to the network management device, the core network device reports the data of the task of the UE and the S1AP identifier to the network management device, and the network management device performs association by using the S1AP identifier.

According to this embodiment, after the UE context is matched with the RLF context, the data of the task of the UE can be associated with the RLF data, so that the reason that the UE encounters the RLF can be found easily, and the accurate basis is provided for network optimization.

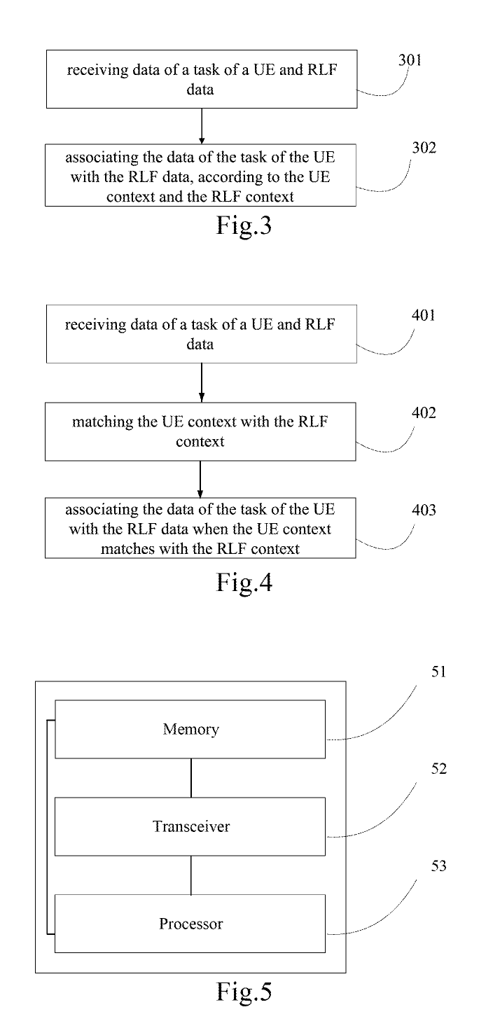

Another embodiment of the present invention provides a method for processing context, which can be performed by multiple kinds of network element device, and a network management device is taken as an example for illustrating below. As shown in FIG. 3, this embodiment includes the following steps.

301: receiving data of a task of a UE and RLF data, wherein the data of the task of the UE carries UE context, and the RLF data carries RLF context. Alternatively, the data of the task of the UE and the RLF data are from an access network device or a core network device. The task of the UE in this embodiment includes but not limited to MDT, RRM measurement, QoS measurement or QoE measurement.

302: associating the data of the task of the UE with the RLF data, according to the UE context and the RLF context.

Alternatively, after the UE context is matched with the RLF context, the data of the task of the UE and the RLF data are associated. Whether the UE context is matched with the RLF context or not matched with the RLF context, please refer to the example in step 204 of the aforementioned embodiment, and repeated description is omitted here.

Alternatively, the UE context or the RLF context includes one or more of the following identifiers, which including an S1AP identifier, a calling number, a session identifier, a C-RNTI or a Short-MAC identifier of the UE.

Alternatively, when the task performed by the UE is minimum drive test MDT, the identifier of the task of the UE may be TR, or TRSR, or combination of the TR and the TRSR. The RLF context can include an S1AP identifier. The network management device associates the data of the task of the UE with the RLF data according to the identifier of the task of the UE and the S1AP identifier.

According to the method provided by this embodiment, data of a task of the UE and RLF data can be associated according to the UE context and the RLF context, so that the RLF context of the UE can be fully utilized.

Another embodiment of the present invention provides a method for processing context, which can be performed by multiple kinds of network element device, and a network management device is taken as an example for illustration below. As shown in FIG. 4, this embodiment includes the following steps.

401: receiving data of a task of a UE and RLF data, wherein the data of the task of the UE carries UE context, and the RLF data carries RLF context.

For example, the network management device receives the data of the task of the UE and the RLF data, which are reported by an access network device or a core network device. This embodiment will be described by taking an access network device as an example, and the actual application also includes but not limited to a core network device.

The task of the UE in this embodiment includes but not limited to MDT, RRM measurement, QoS measurement or QoE measurement.

402: matching the UE context with the RLF context.

Alternatively, in this step, matching includes anyone of the following items: determining whether the UE context and the RLF context are the same; or, determining whether the UE context and the RLF context are partially same; or, determining whether the UE context is included in the RLF context; or, determining whether the RLF context is included in the UE context. If the results of the aforementioned determining actions are yes, the UE context is matched with the RLF context.

Alternatively, whether the UE context is matched with the RLF context can be determined according to S1AP identifier or terminal identifier in the RLF context or S1AP identifier or terminal identifier in the UE context.

When the network element device is an access network device, the S1AP identifier can be found by the access network device according to a C-RNTI or a Short-MAC identifier included in the RLF context or the UE context and the S1AP identifier can be received by the network management device. The terminal identifier can be found by the access network device according to a C-RNTI or a Short-MAC identifier included in the RLF context or the UE context and the terminal identifier can be received by the network management device. When the network element device is a core network device, the S1AP identifier can be found by the network management device according to a C-RNTI or a Short-MAC identifier included in the RLF context or the UE context received from the access network device by the core network device. The S1AP identifier can be found by the network management device according to a C-RNTI or a Short-MAC identifier included in the RLF context or the UE context received from the access network device by the core network device.

Alternatively, the UE context can be searched and reported by the access network device or the core network device according to the identifier of the task of the UE. The identifier of the task of the UE can be TR, or TRSR, or combination of the TR and the TRSR.

403: associating the data of the task of the UE with the RLF data when the UE context matches with the RLF context.

According to the data associating method provided in the embodiment of the present invention, after data of a task of a UE and RLF data are received, the network management device can match the UE context with the RLF context according to an S1AP identifier or a terminal identifier, and further associates the data of the task of the UE and the RLF data, so that the problem that the RLF context of the UE cannot be fully utilized due to improper release of the UE context in the prior art is solved, the RLF context reported after the UE encounters the RLF can be matched with the UE context of the UE, which is favorable for network optimization.

Another embodiment in the present invention provides a device, which can be used for implementing the methods provided in the aforementioned embodiments. As shown in FIG. 5, the device may include a memory 51, a transceiver 52 and a processor 53.

The memory 51 is configured to store UE context of a UE. The transceiver 52 is configured to acquire RLF context of the UE if the UE encounters RLF. The processor 53 is configured to match the UE context stored by the memory with the RLF context acquired by the transceiver.

Alternatively, the transceiver 52 is further configured to receive the UE context and supply the UE context to the memory 51. Alternatively, the transceiver 52 is further configured to receive indication information sent by a network management device.

Alternatively, the processor 53 is further configured to judge whether the indication information is used for indicating to store the UE context, if the indication information is used for indicating to store the UE context, the processor controls the transceiver 52 to supply the UE context to the memory 51. Specifically, the processor 53 is configured to control the transceiver 52 to supply the UE context meeting a type requirement and/or a size requirement of the UE context required to be stored to the memory 51.

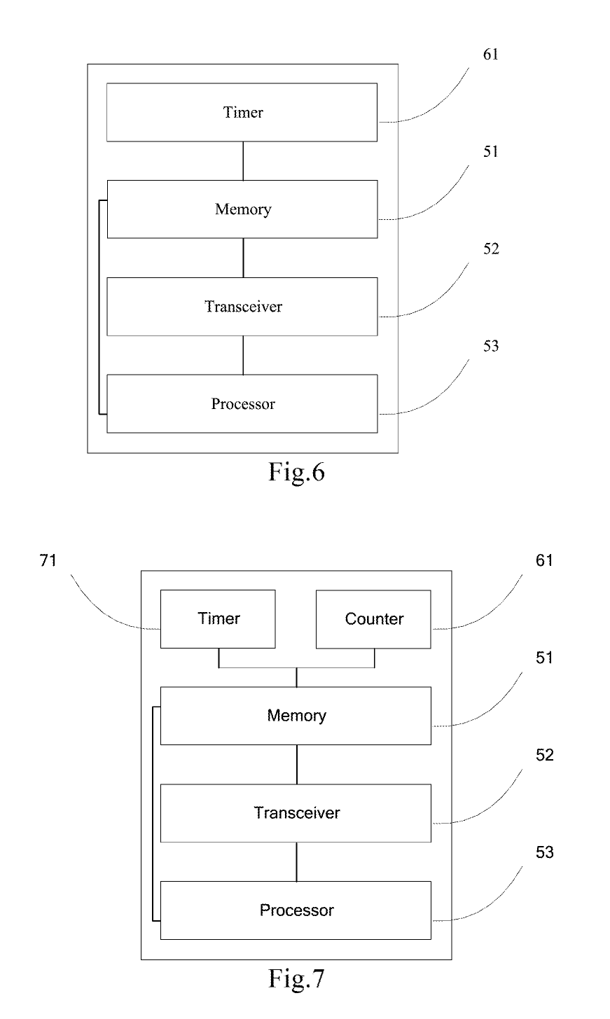

Alternatively, as shown in FIG. 6, the device also includes a timer 61. Timing length of the timer 61 meets a time length requirement for storing the UE context, and the timer 61 is started when the memory 51 stores the UE context. The memory 51 deletes the UE context when the timer 61 reaches the timing length.

Alternatively, as shown in FIG. 7, the device also includes a counter 71. The maximum counting value of the counter 71 meets a number-of-times requirement for storing the UE context, and the counter 71 counts the number every time when the memory 61 stores the UE context. The memory 51 deletes the UE context when the counter 71 reaches the maximum counting value.

Alternatively, the transceiver 52 is further configured to receive any one or more of indication information: indication information for indicating a type requirement of UE context required to be stored; or indication information for indicating a size requirement of UE context required to be stored; or indication information for indicating a time length requirement for storing the UE context; or indication information for indicating a number-of-times requirement for storing the UE context.

Alternatively, the memory 51 is further configured to store a correspondence between an identifier of a task of the UE and the UE context.

Alternatively, the processor 53 is specifically configured to determine whether the UE context and the RLF context are the same; or, determine whether the UE context and the RLF context are partially same; or, determine whether the UE context is included in the RLF context; or, determine whether the RLF context is included in the UE context.

Alternatively, the transceiver 52 is further configured to acquire RLF data of the UE and associate the RLF data with data of a task of the UE; or the transceiver 52 is further configured to acquire the RLF data of the UE, and send the RLF data and data of a task of the UE to a network management device.

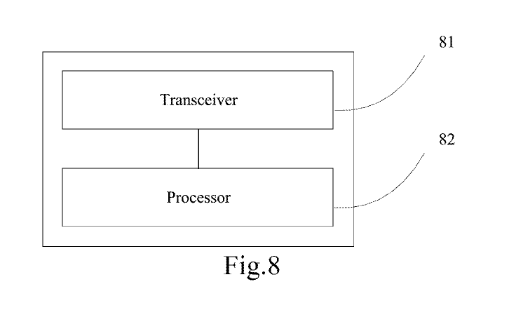

Alternatively, another embodiment of the present invention provides a device, which can be used for implementing the steps performed by network management device in the methods provided in the aforementioned embodiments. As shown in FIG. 8, the device may include a transceiver 81 and a processor 82. The transceiver 81 is configured to receive data of a task of a UE and RLF data of the UE, wherein the data of the task of the UE carries UE context of the UE, and the RLF data carries RLF context of the UE; and the processor 82 is configured to associate the data of the task of the UE with the RLF data, according to the UE context and the RLF context.

Alternatively, the processor 82 is specifically configured to associate the data of the task of the UE with the RLF data when determine that the UE context matches with the RLF context according to the RLF context. Alternatively, the processor 82 is specifically configured to associate the data of the task of the UE with the RLF data when one of the following items is determined: determining whether the UE context and the RLF context are the same; or, determining whether the UE context and the RLF context are partially same; or, determining whether the UE context is included in the RLF context; or, determining whether the RLF context is included in the UE context.

The task of the UE in all the embodiments of the present invention includes but not only limited to minimum drive test, radio resource management measurement, quality of service measurement or quality of experience measurement.

Through the description of the embodiments above, those skilled in the art may clearly understand that the present invention can be realized by means of software and necessary general hardware, and of course, can be realized through hardware, but the former is preferable embodiments under many conditions. Based on such an understanding, the technical solution of the present invention substantially or the part of the present invention making contribution to the prior art can be embodied in the form of a software product, and the computer software product is stored in a storage medium, such as soft disk, hard disk or optical disk of a computer and the like, which includes a plurality of instructions enabling computer equipment (which may be a personal computer, a server, or network equipment and the like) to execute the methods of the embodiments of the present invention.

The foregoing is only some specific embodiments of the invention without limited to the protection scope of the invention. It is easy for those skilled in the art to conceive changes or substitutions within the technical scope disclosed by the invention, which should fall in the protection scope of the invention. Therefore, the protection scope of the present invention should be defined by that of the claims.

What is claimed is:

1. A method for processing context comprising:
receiving, by a network management device, data of a task of a user equipment (UE) and radio link failure (RLF) data of the UE, wherein the data of the task of the UE carries UE context of the UE, and the RLF data carries RLF context of the UE; and
associating, by the network management device, the data of the task of the UE with the RLF data, according to the UE context and the RLF context.

2. The method for processing the context according to claim 1, wherein associating, by the network management device, the data of the task of the UE with the RLF data, according to the UE context and the RLF context comprises:
determining that the UE context matches with the RLF context; and
associating, by the network management device, the data of the task of the UE with the RLF data when determining that the UE context matches with the RLF context.

3. The method for processing the context according to claim 2, wherein determining that the UE context matches with the RLF context comprises:
determining, by the network management device, the UE context and the RLF context are the same; or,
determining, by the network management device, the UE context and the RLF context are partially same; or,
determining, by the network management device, the UE context is included in the RLF context; or,
determining, by the network management device, the RLF context is included in the UE context.

4. The method for processing the context according to claim 2, wherein determining that the UE context matches with the RLF context comprises:
determining, by the network management device, that the UE context matches with the RLF context according to an S1 application protocol (S1AP) identifier or a terminal identifier included in the RLF context; or,
determining, by the network management device, that the UE context matches with the RLF context according to an S1 application protocol (S1AP) identifier or a terminal identifier included in the UE context.

5. The method for processing the context according to claim 4, wherein
the S1AP identifier is found and reported by an access network device according to a cell radio network temporary identifier (C-RNTI) or a short-message authentication code (Short-MAC) identifier included in the RLF context; or,
the S1AP identifier is found and reported by an access network device according to a C-RNTI or a Short-MAC identifier included in the UE context; or
the S1AP identifier is found and reported by a core network device according to a C-RNTI or a Short-MAC identifier included in the RLF context received from an access network device; or,
the S1AP identifier is found and reported by a core network device according to a C-RNTI or a Short-MAC identifier included in the UE context received from an access network device; or,
the S1AP identifier is found and reported by an access network device or a core network device according to an identifier of the task of the UE.

6. The method for processing the context according to claim 4, wherein
the terminal identifier is found and reported by an access network device according to a cell radio network temporary identifier (C-RNTI) or a short-message authentication code (Short-MAC) identifier included in the RLF context; or,
the terminal identifier is found and reported by an access network device according to a C-RNTI or a Short-MAC identifier included in the UE context; or
the terminal identifier is found and reported by a core network device according to a C-RNTI or a Short-MAC identifier included in the RLF context received from an access network device; or,
the terminal identifier is found and reported by a core network device according to a C-RNTI or a Short-MAC identifier included in the UE context received from an access network device; or,
the terminal identifier is found and reported by an access network device or a core network device according to an identifier of the task of the UE.

7. The method for processing the context according to claim 1, wherein the UE context is searched and reported by an access network device or a core network device according to an identifier of the task of the UE.

8. The method for processing the context according to claim 1, wherein the task of the UE comprises: minimum drive test (MDT), radio resource management (RRM) measurement, quality of service (QoS) measurement or quality of experience (QoE) measurement.

9. The method for processing the context according to claim 8, wherein when the task of the UE is the MDT, the identifier of the task of the UE is TR, TRSR, or a combination of TR and TRSR.

10. The method for processing the context according to claim 1, wherein the UE context or the RLF context comprises one or more of the following identifiers: an S1 application protocol (S1AP) identifier, a calling number, a session identifier, a cell radio network temporary identifier (C-RNTI), and a short message authentication code (Short-MAC) identifier of the UE.

11. A device comprising:
a transceiver configured to receive data of a task of a user equipment (UE) and radio link failure (RLF) data of the UE, wherein the data of the task of the UE carries UE context of the UE, and the RLF data carries RLF context of the UE; and
a processor configured to associate the data of the task of the UE with the RLF data, according to the UE context and the RLF context.

12. The device according to claim 11, wherein that the processor is configured to associate the data of the task of the UE with the RLF data when determine that the UE context matches with the RLF context.

13. The device according to claim 12, wherein the processor is configured to associate the data of the task of the UE with the RLF data when one of the following items is determined:
determining the UE context and the RLF context are the same;
determining the UE context and the RLF context are partially same;
determining the UE context is included in the RLF context; and
determining the RLF context is included in the UE context.

14. The device according to claim 12, wherein the processor is configured to determine that the UE context matches with the RLF context according to an S1 application protocol (S1AP) identifier or a terminal identifier included in the RLF context; or
the processor is configured to determine that the UE context matches with the RLF context according to an S1 application protocol (S1AP) identifier or a terminal identifier included in the UE context.

15. The device according to claim 14, wherein that the transceiver is configured to receive the S1AP identifier which is found and reported by an access network device according to a cell radio network temporary identifier (C-RNTI) or a short-message authentication code (Short-MAC) identifier included in the RLF context; or
the transceiver is configured to receive the S1AP identifier which is found and reported by an access network device according to a C-RNTI or a Short-MAC identifier included in the UE context; or
the transceiver is configured to receive the S1AP identifier which is found and reported by a core network device according to a C-RNTI or a Short-MAC identifier included in the RLF context received from an access network device; or,
the transceiver is configured to receive the S1AP identifier which is found and reported by a core network device according to a C-RNTI or a Short-MAC identifier included in the UE context received from an access network device; or,
the transceiver is configured to receive the S1AP identifier which is found and reported by an access network device or a core network device according to an identifier of the task of the UE.

16. The device according to claim 14, wherein that the transceiver is configured to receive the terminal identifier which is found and reported by an access network device according to a cell radio network temporary identifier (C-RNTI) or a short-message authentication code (Short-MAC) identifier included in the RLF context; or,
the transceiver is configured to receive the terminal identifier which is found and reported by an access network device according to a C-RNTI or a Short-MAC identifier included in the UE context; or
the transceiver is configured to receive the terminal identifier which is found and reported by a core network device according to a C-RNTI or a Short-MAC identifier included in the RLF context received from an access network device; or,
the transceiver is configured to receive the terminal identifier which is found and reported by a core network device according to a C-RNTI or a Short-MAC identifier included in the UE context received from an access network device; or,
the transceiver is configured to receive the terminal identifier which is found and reported by an access network device or a core network device according to an identifier of the task of the UE.

17. The device according to claim 11, wherein that the transceiver is configured to receive the UE context which is searched and reported by an access network device or a core network device according to an identifier of the task of the UE.

18. The device according to claim 11, the transceiver, configured to receive data of a task of a user equipment (UE) and radio link failure (RLF) data of the UE, wherein the task of the UE comprises: minimum drive test (MDT), radio resource management (RRM) measurement, quality of service (QoS) measurement or quality of experience (QoE) measurement.

19. The device according to claim 18, the transceiver, configured to receive data of a task of a user equipment (UE) and radio link failure (RLF) data of the UE, wherein the task of the UE comprises: minimum drive test (MDT), radio resource management (RRM) measurement, quality of service (QoS) measurement or quality of experience (QoE) measurement, when the task of the UE is the MDT, the identifier of the task of the UE is TR, TRSR or combination of TR and TRSR.

20. The device according to claim 11, the transceiver, configured to receive data of a task of a user equipment (UE) and radio link failure (RLF) data of the UE, wherein the data of the task of the UE carries UE context of the UE, and the RLF data carries RLF context of the UE, the UE context or the RLF context comprises one or more of the following identifiers: an S1 application protocol (S1AP) identifier, a calling number, a session identifier, a cell radio network temporary identifier (C-RNTI), and a short message authentication code (Short-MAC) identifier of the UE.
